(19) United States
(12) Patent Application Publication
(10) Pub. No.: US 2006/0093760 A1
(43) Pub. Date: May 4, 2006

(54) Ink-jet recording sheet and producing method of the same

(75) Inventors: Yukako Taka, Tokyo (JP); Toshihiko Iwasaki, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/253,411

(22) Filed: Oct. 19, 2005

(30) Foreign Application Priority Data
Oct. 28, 2004 (JP) JP2004-313631

(51) Int. Cl. B41M 5/00

(52) U.S. Cl. 428/32.1

(57) ABSTRACT

An ink-jet recording sheet comprising a non-water absorbing support having thereon at least two simultaneously coated ink-absorbing layers, each ink-absorbing layer containing silica particles, wherein: (i) an outermost layer of the ink-absorbing layers and a layer adjacent to the outermost layer each contains a water-soluble multivalent metal compound; (ii) the outermost layer is formed by a coating composition having an average zeta potential of not less than +50 mV at 25° C.; (iii) a MO_{x/2}/SiO₂ value in the layer adjacent to the outermost layer is in the range of 0.005-0.02, provided that MO_{x/2} represents a weight of the water-soluble multivalent metal compound represented by a weight of MO_{x/2}, and SiO₂ represents a weight of the silica particles; and (iv) a MO_{x/2}/SiO₂ value in the outermost layer is larger than a MO_{x/2}/SiO₂ value in any ink-absorbing layer other than the outermost layer, wherein: M represents a metal having a valence of two or more contained in the water-soluble multivalent metal compound; and x represents a valence of the metal M.

This application is based on Japanese Patent Application No. 2004-313631 filed on Oct. 28, 2004, in Japanese Patent Office, the entire content of which is hereby incorporated by reference.

### FIELD OF THE INVENTION

The present invention relates to an ink-jet recording sheet exhibiting a high image density and high glossiness, and also relates to a producing method of the same.

### BACKGROUND OF THE INVENTION

The quality of ink-jet print images has rapidly increased in recent years and is becoming closer to the image quality of silver halide photography. As a method to attain image quality comparative to that of silver halide photography, well known is to use an ink-jet recording sheet prepared from a high flatness non-water absorbing support having thereon an ink-absorbing microporous layer.

This ink-absorbing layer mainly contains a hydrophilic binder and particles which are generally inorganic particles.

The ink-jet recording method generally includes two major methods, namely, (i) a method in which a water-soluble dye is used in the ink and (ii) a method in which a pigment is used in the ink. When an ink containing a pigment is used, the obtained image shows high durability, however, it is difficult to obtain an image comparative to silver halide photography because of an imagewise change of glossiness. When an ink containing a water soluble dye is used, a color print obtained by using the ink shows high clarity of the image and a homogeneous glossiness on the surface, and a color print having a quality comparative to that of a silver halide photograph is obtained.

However, the ink-jet print image obtained by using an ink containing a water-soluble dye tends to suffer from bleeding of the dye under high humidity conditions. In order to avoid this problem, one of the generally employed methods is to add a cationic material to fix the dye in the microporous layer.

For example, preferably employed is a method to strongly fix an anionic dye using a cationic polymer, whereby a strong bond is formed between the anionic dye and the cationic polymer. One of the examples of a cationic polymer includes a polymerized quaternary ammonium salt. Detailed information on the cationic polymer is shown in “Materials and Technology on Ink-jet Printer” published by CMC Publ., July, 1998 in Japan and in Japanese Patent Publication Open to Public Inspection (hereafter referred to as JP-A) No. 9-193532. Also, in JP-A Nos. 60-257286, 61-57379 and 60-67190, a method is proposed in which a water-soluble multivalent metal compound is added to or impregnated in an ink-jet recording sheet to aggregate and fix the dye contained in an ink-jet ink when printed. However, this method is not fully satisfactory, because fixing the dye in the outermost surface of an ink-jet recording sheet is not fully enough, resulting in exhibiting not fully sufficient image density.

In Published Japanese translation of a PCT application No. 2002-526564 and in JP-A No. 2002-320842, disclosed are examples in which a water-soluble aluminum compound and vapor deposited silica are used, however, these examples do not teach ink-jet recording sheets containing multi-layers and the image density is not fully satisfactory. A method to attain high image density or excellent color reproducibility by incorporating an aluminum salt in a coating composition for an outermost layer is disclosed in Patent Document 1, and an ink-jet recording sheet having an aluminum compound or a zirconium compound in a portion apart from the support of the ink-jet recording sheet is disclosed in Patent Document 2. However, these methods tend to cause degradation in glossiness and coating defects in which stripes are formed when a simultaneously coating method is used.
(Patent Document 1) JP-A No. 2001-287451
(Patent Document 2) JP-A No. 2002-160442

### SUMMARY OF THE INVENTION

An object of the present invention is to provide an ink-jet recording sheet exhibiting high image density and glossiness, and being free from coating defects (stripes or cracks) when the sheet is formed by using a simultaneous coating method, as well as to provide a producing method thereof.

One of the aspects of the present invention is an ink-jet recording sheet comprising a non-water absorbing support having thereon at least two simultaneously coated ink-absorbing layers, each ink-absorbing layer-containing silica particles, wherein: (i) an outermost layer of the ink-absorbing layers and a layer adjacent to the outermost layer each contains a water-soluble multivalent metal compound; (ii) the outermost layer is formed by a coating composition having an average zeta potential of not less than +50 mV at 25° C.; (iii) a MO_{x/2}/SiO₂ value in the layer adjacent to the outermost layer is in the range of 0.005-0.02, provided that MO_{x/2} represents a weight of the water-soluble multivalent metal compound represented by a weight of MO_{x/2}, and SiO₂ represents a weight of the silica particles; and (iv) a MO_{x/2}/SiO₂ value in the outermost layer is larger than a MO_{x/2}/SiO₂ value in any ink-absorbing layer other than the outermost layer, wherein: M represents a metal having a valence of two or more contained in the water-soluble multivalent metal compound; and x represents a valence of the metal M.

### BRIEF DESCRIPTION OF THE DRAWINGS

FIG. 1 illustrates a typical example of a clear peak in a thickness distribution of secondary ion intensity of an ink-absorbing layer showing existence of a multivalent metal.

### DESCRIPTION OF THE PREFERRED EMBODIMENTS

The above object of the present invention is achieved by the following structures.

(1) An ink-jet recording sheet comprising a non-water absorbing support having thereon at least two simultaneously coated ink-absorbing layers, each ink-absorbing layer containing silica particles,

wherein:

(i) an outermost layer of the ink-absorbing layers and a layer adjacent to the outermost layer each contains a water-soluble multivalent metal compound;

(ii) the outermost layer-is formed by a coating composition having an average zeta potential of not less than +50 mV at 25° C.;

(iii) a MO_{x/2}/SiO₂ value in the layer adjacent to the outermost layer is in the range of 0.005-0.02, provided that MO_{x/2} represents a weight of the water-soluble multivalent metal compound based on a weight of MO_{x/2}, and SiO₂ represents a weight of the silica particles; and

(iv) a MO_{x/2}/SiO₂ value in the outermost layer is larger than a MO_{x/2}/SiO₂ value in any ink-absorbing layer other than the outermost layer,
wherein:
M represents a metal having a valence of two or more contained in the water-soluble multivalent metal compound; and
x represents a valence of the metal M.
   (2) An ink-jet recording sheet comprising a non-water absorbing support having thereon at least two simultaneously coated ink-absorbing layers, each ink-absorbing layer containing silica particles,

wherein:

(i) an outermost layer of the ink-absorbing layers further contains a water-soluble multivalent metal compound;

(ii) the outermost layer is formed by a coating composition having an average zeta potential of not less than +50 mV at 25° C.;

(iii) a MO_{x/2}/SiO₂ value in the layer adjacent to the outermost layer is in the range of 0.005-0.02, provided that MO_{x/2} represents a weight of the water-soluble multivalent metal compound based on a weight of MO_{x/2}, and SiO₂ represents a weight of the silica particles; and

(iv) a MO_{x/2}/SiO₂ value in the outermost layer is larger than a MO_{x/2}/SiO₂ value in any ink-absorbing layer other than the outermost layer,
wherein:
M represents a metal having a valence of two or more contained in the water-soluble multivalent metal compound; and
x represents a valence of the metal M.
   (3) An ink-jet recording sheet comprising a non-water absorbing support having thereon at least two simultaneously coated ink-absorbing layers, each ink-absorbing layer containing silica particles,

wherein:

(i) an outermost layer of the ink-absorbing layers and a layer adjacent to the outermost layer each contains a water-soluble multivalent metal compound;

(ii) a thickness distribution of secondary ion intensity showing existence of the water-soluble multivalent metal compound of the ink-absorbing layers exhibits a peak within 10 μm from an outermost surface of the outermost layer, the secondary ion intensity being determined by time of flight secondary ion mass spectrometry (TOF-SIMS);

(iii) a MO_{x/2}/SiO₂ value in the layer adjacent to the outermost layer is in the range of 0.005-0.02, provided that MO_{x/2} represents a weight of the water-soluble multivalent metal compound based on a weight of MO_{x/2}, and SiO₂ represents a weight of the silica particles; and

(iv) a MO_{x/2}/SiO₂ value in the outermost layer is larger than a MO_{x/2}/SiO₂ value in any ink-absorbing layer other than the outermost layer,
wherein:
M represents a metal having a valence of two or more contained in the water-soluble multivalent metal compound; and
x represents a valence of the metal M.
   (4) An ink-jet recording sheet comprising a non-water absorbing support having thereon at least two simultaneously coated ink-absorbing layers, each ink-absorbing layer containing silica particles,

wherein:

(i) an outermost layer of the ink-absorbing layers further contains a water-soluble multivalent metal compound;

(ii) a thickness distribution of secondary ion intensity showing existence of the water-soluble multivalent metal compound of the ink-absorbing layers exhibits a peak within 10 μm from an outermost surface of the outermost layer, the secondary ion intensity being determined by time of flight secondary ion mass spectrometry (TOF-SIMS);

(iii) a difference between a pH value of a coating composition for the outermost layer and a pH value of a coating composition for a layer adjacent to the outermost layer is not more than 0.6 at 25° C.; and

(iv) a MO_{x/2}/SiO₂ value in the outermost layer is larger than a MO_{x/2}/SiO₂ value in any ink-absorbing layer other than the outermost layer, provided that MO_{x/2} represents a weight of the water-soluble multivalent metal compound based on a weight of MO_{x/2}, and SiO₂ represents a weight of the silica particles,
wherein
M represents a metal having a valence of two or more contained in the water-soluble multivalent metal compound; and
x represents a valence of the metal M.
   (5) The ink-jet recording sheet of any one of Items (1) to (4), wherein the MO_{x/2}/SiO₂ value in the outermost layer is not less than 0.1.
   (6) The ink-jet recording sheet of any one of Items (1) to (5), wherein a dry thickness of the outermost layer is in the range of 2-20% of a total dry thickness of the ink-absorbing layers.
   (7) The ink-jet recording sheet of any one of Items (1) to (6), wherein the water-soluble multivalent metal compound contains aluminum atoms or zirconium atoms.
   (8) The ink-jet recording sheet of any one of Items (1) to (7), wherein the water-soluble multivalent metal compound contained in the layer adjacent to the outermost layer and the water-soluble multivalent metal compound contained in the outermost layer contain a common metal element.
   (9) A method for producing the ink-jet recording sheet of any one of Items (1) to (7) comprising the step of:

simultaneously coating at least two coating compositions on the non-water absorbing support to form the ink-absorbing layers,

wherein a viscosity of the coating composition for the outermost layer is higher than a viscosity of a coating composition for the layer adjacent to the outermost layer.

The present invention provides an ink-jet recording sheet exhibiting high image density and glossiness, and being free from coating defects (stripes or cracks) when the sheet is formed by using a simultaneous coating method.

The best mode to carry out the present invention will now be described, however, the present invention is not limited thereto.

The present invention aims to provide an ink-jet recording sheet containing a non-water absorbing support having thereon at least two simultaneously coated ink-absorbing layers, each ink-absorbing layer containing silica particles, wherein the ink-jet recording sheet is free from degradation in image density and glossiness as well as coating defects, for example, stripes when the sheet is formed by using a simultaneous coating method.

In the present invention, various properties of an outermost layer and a layer adjacent to the outermost layer (hereinafter referred to as an adjacent layer) of ink-absorbing layers were examined and it was found that an ink-jet recording sheet exhibiting high image density and glossiness, and being free from coating defects when the sheet is formed by using a simultaneous coating method (coating and drying) was obtained under the following conditions:

(i) the outermost layer of the ink-absorbing layers is formed by a coating composition containing silica particles, which has an average zeta potential of not less than +50 mV at 25° C.;

(ii) a thickness distribution of secondary ion intensity showing existence of the water-soluble multivalent metal compound in the ink-absorbing layer (a distribution of secondary ion intensity in the thickness direction of the ink-absorbing layer) exhibits a peak within 10 μm from the outermost surface, the thickness distribution of secondary ion intensity being determined by TOF-SIMS (Time of Flight-Secondary Ion Mass Spectrometry);

(iii) a difference between the pH value of a coating composition for the outermost layer and the pH value of a coating composition for an adjacent layer is not more than 0.6 at 25° C.;

(iv) an outermost layer of the ink-absorbing layers and an adjacent layer contain a water-soluble multivalent metal compound, in addition to the silica particles, and the weight ratio of silica and the water-soluble multivalent metal compound is within a prescribed range; and

(v) the MO_{x/2}/SiO₂ value in the outermost layer is larger than the MO_{x/2}/SiO₂ value in any of the ink-absorbing layers except for the outermost layer,

wherein: the MO_{x/2}/SiO₂ value represents a value of a weight of a water-soluble multivalent metal oxide contained in an ink-absorbing layer devided by a weight of the silica particles contained in the ink-absorbing layer, the weight of the water-soluble multivalent metal oxide being converted from the weight of a water-soluble multivalent metal compound contained in the ink-absorbing layer,
wherein M represents a metal having a valence of two or more contained in the water-soluble multivalent metal compound and x represents a valence of the metal M.

The reason why the above conditions are desirable in the present invention will now be explained in the following:

In order to fix an anionic ink-jet ink in the outer most layer, it is desirable that the outermost layer of the ink-absorbing layers is formed by a coating composition containing silica particles, which has an average zeta potential of not less than +50 mV at 25° C. or that a thickness distribution of secondary ion intensity of the multivalent metal in the ink-absorbing layer exhibits a peak within 10 μm from the outermost surface. However, when cationic natures of the outermost layer and the adjacent layer largely differ, aggregation easily occurs at the interface of the two layers, when these layers are simultaneously coated. This aggregation causes defects at the interface and forms a ragged interface resulting in loss of glossiness of the ink-jet recording sheet. Accordingly, in the present invention, a prescribed amount of multivalent metal compound is incorporated in the adjacent layer or the difference between the pH values of the coating compositions for the outermost layer and the adjacent layer is controlled to be not more than 0.6 at 25° C. These conditions reduce the difference in cationic natures of the coating compositions while keeping a high image density of the ink-jet recording sheet. As a result, formation of defects at the interface of the ink-absorbing layers is avoided even when the layers are formed by a simultaneous coating method, whereby an ink-jet recording sheet exhibiting high glossiness is obtained. Further, by controlling the ratio of (multivalent metal compound)/(silica) within a prescribed ratio or by reducing the thickness of the outermost layer, coating defects of the ink-absorbing layer are eliminated while keeping high a high image density of the ink-jet recording sheet.

Any kinds of acids and alkalis are usable for controlling the pH value of a coating composition. The difference in the pH values is preferably not more than 0.6 in the present invention and it is preferably not more than 0.3 in order to avoid aggregations at the surface.

By controlling the viscosity of the coating composition for the outermost layer to be higher than the viscosity of the coating composition for the adjacent layer, and controlling the dynamic surface tension of the coating composition for the outermost layer to be lower than the dynamic surface tension of the coating composition for the adjacent layer, occurrence of coating defects while the layers are simultaneously coated are reduced.

Detailed structures of the present invention will now be explained:

(Water-Soluble Multivalent Metal Compound)

Examples of a water-soluble multivalent metal compound used in the present invention include: chlorides, sulfates, nitrates, acetates, formates, succinates, malonates, chloro acetates of metals, for example, aluminum, calcium, magnesium, zinc, iron, strontium, barium, nickel, copper, scandium, gallium, indium, titanium, zirconium, tin, and lead. Of these, water soluble salts of aluminum, calcium, magnesium, zinc, and zirconium are preferable because the metal ions are colorless. Specifically preferable compounds include water-soluble multivalent metal compounds of aluminum and zirconium from the viewpoint of pH value and operator safety.

Examples of a water-soluble aluminum compound include: polyaluminum chloride (basic aluminum chloride), aluminum sulfate, basic aluminum sulfate, aluminum potassium sulfate (alum), aluminum sodium sulfate, aluminum nitrate, aluminum phosphate, aluminum carbonate, polyaluminum sulfate silicate, aluminum acetate and basic aluminum lactate. Herein, the term “water-soluble” means that not less than 1 wt % of a compound or more preferably not less than 3 wt % of a compound is dissolved in water at 25° C. Among the above listed compounds, basic aluminum chloride, basic aluminum sulfate, basic aluminum lactate and aluminum subacetate are preferable.

One of the most preferable water-soluble multivalent metal compounds is basic aluminum chloride having a basicity of 80 or more which is represented by the following formula:
[Al₂(OH)ₙCl₆₋ₙ]ₘ (wherein, 0<n<6, m≦10)

Examples of a water-soluble zirconium compound include: zirconyl carbonate, zirconyl ammonium carbonate, zirconyl acetate, zirconyl nitrate, acid zirconium chloride, zirconyl lactate and zirconyl citrate. Of these, zirconyl ammonium carbonate and zirconyl acetate are preferable, and specifically preferable is zirconyl acetate.

The method of adding the above mentioned water-soluble multivalent metal compounds to the outermost layer or the adjacent layer is not specifically limited. These compounds may be added to a coating- composition for an ink-absorbing layer, or may be added to a silica dispersion to be added to the coating composition for an ink-absorbing layer.

The amount of the water-soluble multivalent metal compound included in the outermost layer is preferably 0.2 g/m² or more, wherein the amount of the water-soluble metal compound is a converted value to the amount of the same equivalent of water-soluble multivalent metal oxide.

In the present invention, from the viewpoint of obtaining high image density, the content of a water-soluble multivalent metal compound in the outermost layer preferably satisfies the following relationship:
MO_{x/2}/SiO₂≧0.1
as described in the above Item (4), or more preferably:
MO_{x/2}/SiO₂≧0.2
wherein the meaning of the MO_{x/2}/SiO₂ value is explained in the above Items (1) through (4). In the expression of MO_{x/2}/SiO₂, for example, in the case of Al which is a trivalent metal, the oxide is usually represented as Al₂O₃ (alumina), however, in the above expression, it is represented as AlO_{3/2}. From a viewpoint of attaining high image density as well as preventing the aggregation at the interface of the outermost layer and the adjacent layer, the MO_{x/2}/SiO₂ value in the adjacent layer is preferably in the range of 0.005 to 0.02 or, alternatively, the difference between the pH values of coating compositions for the outermost layer and the adjacent layer is preferably not more than 0.6 at 25° C. When the MO_{x/2}/SiO₂ value in the adjacent layer is 0.02 or more, the image density decreases and, when the MO_{x/2}/SiO₂ value in the adjacent layer is 0.005 or less, aggregation occurs at the interface of the outermost layer and the adjacent layer resulting in an increase of coating defects and degradation of glossiness.

From the viewpoint of attaining high image density, the dry thickness of the outermost layer is preferably 2 to 20% and more preferably 5 to 15% of the total dry thickness of the ink-jet recording sheet. The thickness of the adjacent layer is not specifically limited, however, it is preferably thicker than the thickness of the outermost layer. The MO_{x/2}/SiO₂ value in the outermost layer is preferably larger than any of the MO_{x/2}/SiO₂ values in other layers.

(Zeta (ζ) Potential)

As described in the above Items (1) and (2), one of the characteristic features of the present invention is that the zeta potential of the coating composition containing silica particles for forming the outermost layer is 50 mV or more. One of the examples to obtain a zeta potential of that high is to cationize the silica particles by using a water-soluble multivalent metal compound or a highly cationic polymer, for example, polyallylamine, and to control the amount of the cation. The zeta potential is measured in a solution containing 3% by weight of silica in a solid content at 25° C. using a zeta potential meter for concentrated solutions (ESA-9800, Matec Applied Science).

(Secondary Ion Intensity Peak)

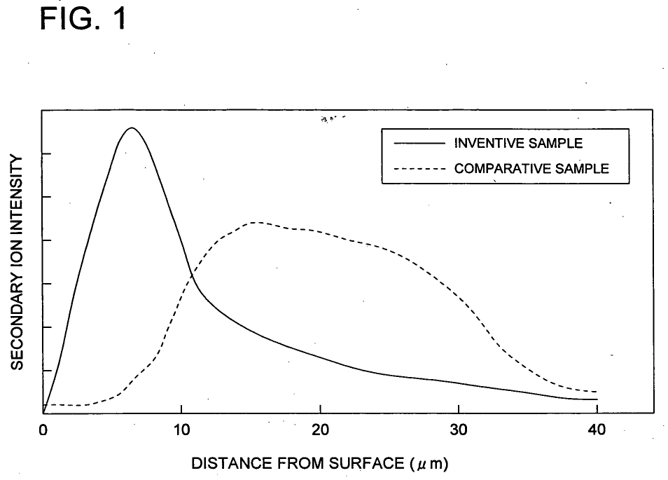

In the ink-jet recording sheet of the present invention, it is important to localize a water-soluble multivalent metal compound to a high concentration near the surface of the outermost layer of ink-absorbing layers. The localization of the metal of a water-soluble multivalent metal compound is measured by using time of flight secondary ion mass spectrometry (TOF-SIMS) in which secondary ion intensity showing the existence of the multivalent metal is detected. The localization of the multivalent metal near the outermost surface of an ink-absorbing layer is achieved by controlling the thickness of the outermost layer so that the thickness distribution of a secondary ion intensity in the ink-absorbing layers exhibits a peak within 10 μm from the surface of the outermost layer as shown in FIG. 1.

The amount of the water-soluble multivalent metal compound included in the outermost layer is preferably in the range of 0.2 to 1.0 g/m² as a value converted to the same equivalent of multivalent metal oxide. The water-soluble multivalent metal compound may be contained in other ink-absorbing layers other than the outermost layer. In this case, the amount of the water-soluble multivalent metal compound contained in the layer other than the outermost layer is preferably not more than 20% of the amount of the water-soluble multivalent metal compound contained in the outermost layer, wherein the amount of the water-soluble metal compound is a converted value to the amount of the same equivalent of water-soluble multivalent metal oxide.

It is important, in the present invention, that the thickness distribution of a secondary ion intensity in the ink-absorbing layers exhibits a peak within 10 μm from the surface of the outermost layer.

The thickness distribution of the water-soluble multivalent metal compound in the ink-absorbing layer is determined as follows: A specimen exposing the cross-section of an ink-jet recording sheet is prepared employing a microtome. The thickness distribution of the element or the secondary ion intensity specific to the multivalent metal is obtained employing an electron probe microanalyzer (EPMA) or a time of flight secondary ion mass spectrometer (TOF-SIMS). Specifically preferable is the method using TOF-SIMS in which the distribution of the secondary ion fragment specific to the multivalent metal along the depth direction is obtained, since this method also provides information on the chemical structure of the multivalent metal compound. In regard to secondary ion mass spectrography, the following literature may be referred to: for example, TOF-SIMS: Surface Analysis by Mass Spectrometry (published by Surface Spectra Co.), edited by John C. Vickerman and David Briggs, and “Niji Ion Shitsuryo Bunseki Hou (Secondary Ion Mass Spectrometry) (Hyomen Bunseki Gijutsu Sensho (Surface Analysis Technology Series)) published by Maruzen.

A practical determination method is as follows: An ink-absorbing layer is sliced employing a microtome so that a flat cross-section is exposed and the resulting cross-section of the ink-absorbing layer is subjected to TOF-SIMS determination. Preferred as primary ions during the TOF-SIMS determination are metal ions such as Au⁺, In⁺, Cs⁺, or Ga⁺, of which, preferred are In⁺ and Ga⁺. The preferable secondary ion to be detected is selected based on the secondary ion mass spectra of multivalent metals, previously determined. The primary ion acceleration voltage is preferably 20-30 kV. It is preferable that various adjustments are performed so that the beam diameter determined by a knife edge method is at most 0.25 μm. Exposure conditions such as beam current and exposure time may vary as appropriate. Listed as a typical example of preferable determination conditions are a primary ion beam current of 0.9 nA and an exposure time of 20 minutes. Incidentally, since an ink-jet recording sheet or an ink-absorbing layer are not sufficiently conductive, it is preferable to suitably perform static neutralization by employing a neutralizing electron gun.

During the measurement, the primary ion beam is scanned in the range capable of measuring the entire region of the ink-absorbing layer. Typically, a 40 μm square is scanned. It is possible to obtain an image of a chemical species in the ink-absorbing layer based on the scanning position of the primary ion beam and the detected secondary ion. In the above scanning region, the mass spectra of the secondary ion is preferably measured at 256×256 points and the image of the chemical species is obtained by recording the intensity Of the targeted secondary ion peak, based on the resulting mass spectra. Further, based on the resulting image, by integrating the peak intensity of the portion at the same thickness, it is possible to obtain a thickness distribution of the specified secondary ion. Formation of the image and distribution of the secondary ion is performed utilizing functions usually accompanied with software for data processing of a secondary ion mass spectrometer. In the present invention, it is possible to utilize the above functions.

In the present invention, in the above distribution of a multivalent metal in the thickness direction, a portion in which the secondary ion intensity, derived from a multivalent metal in the ink-absorbing layer, is 1.5 times its minimum value is specified as a multivalent metal existing portion. Further, the position and thickness of the ink-absorbing layer are specified, in the same manner as for the multivalent metal ion, as a region in which a metal ion incorporated in silica particles existing in the ink absorptive layer is detected. In the present invention, TRIEF-II produced by Pysical Electronics has been used and the distribution of a multivalent metal in the depth direction of an ink-absorbing layer is determined as shown in FIG. 1.

The distribution profile shown by a broken line in FIG. 1 was obtained for an ink-absorbing layer formed by a coating solution which was prepared by adding a multivalent metal compound into a conventional ink-absorbing layer coating solution. In this profile, the maximum value of the secondary ion intensity, due to the multivalent metal compound, is present in the interior of the ink-absorbing layer (in FIG. 1, at a depth of approximately 15 μm). As a result, ink deposited onto the outermost surface is fixed in the interior of the ink absorptive layer, whereby a high image density is not attained. On the other hand, the distribution profile shown by a solid line in FIG. 1 was obtained for an ink-absorbing layer formed through the method of the present invention. In this profile, the maximum value of the secondary ion intensity, due to the multivalent metal compound, is present within 10 μm of the outermost surface, which means that the ink deposited on the surface is fixed at a position closer to the outermost surface, whereby a higher image density is obtained.

(Silica Particles)

Examples of silica particles usable in the present invention include: precipitated silica (obtained in a wet process), vapor deposited silica and choroidal silica. Of these, vapor deposited silica is preferable in the present invention.

The average primary particle diameter of the silica particles is preferably 3-100 nm. When the average primary particle diameter is not more than nm, it is possible to achieve the desired high glossiness of recording sheets, and it is also possible to produce an image with high clarity by minimizing a decrease in maximum density due to diffused surface reflection. The above average particle diameter of particles is determined as follows. Particles, as well as the cross-section or surface of a porous ink-absorbing layer are observed employing an electron microscope and the particle diameters of many randomly selected particles are determined. Subsequently, the simple average value (number average) is calculated. Herein, a particle diameter is represented by the diameter of a circle which has the same area as the projective area of a particle.

Specifically preferred embodiments follow. Secondary or higher order particles are formed and a porous ink-absorbing layer is then prepared. In that case, in view of preparing recording sheets which exhibit high ink absorbing capability and high glossiness, the average particle diameter is preferably 20-200 nm.

By incorporation silica particles, an ink-absorbing layer having high porosity and a high ink-absorbing capacity is obtained in the present invention. The amount of added silica particles varies widely depending on the desired amount of ink-absorption, the void ratio of the porous ink-absorbing layer, and the kind of a hydrophilic binder, however, is commonly 5-30 g per 1 m² of the recording sheet, and is preferably 10-25 g per 1 m² of the recording sheet. The ratio of vapor deposited silica particles to a hydrophilic binder by weight is commonly 2:1-20:1, and is preferably 3:1-10:1.

As the added amount of silica particles increases, the ink absorption capacity also increases. However, degradation of performance such as curling and cracking tend to occur. Consequently, a method is preferred in which the ink absorption capacity is increased by controlling the void ratio, the preferred void ratio of which is 40-75 percent. It is possible to control the void ratio according to the type of selected silica particles and binders, or based on the mixing ratio thereof, as well as the amount of other additives.

“Void ratio”, as described herein, refers to the ratio of the total void volume to the volume of the void layer. It is possible to calculate the void ratio based on the total volume of layer-forming materials and the layer thickness.

The method to simultaneously coating at least two ink-absorbing layers of the present invention may be selected from well known coating methods. Examples of the coating method include: a gravure coating method, a roll coating method, a rod bar coating method, an air knife coating method, an extrusion coating method and an extrusion coating method using a hopper, as disclosed in U.S. Pat. No. 2,681,294. As mentioned in the above Item (9), it was found, in the present invention, that by controlling the dynamic surface tension of the outermost layer of the ink-absorbing layers lower than that of the adjacent layer (the layer adjacent to the outermost layer), occurrence of coating defects are effectively avoided. The viscosity of a coating solution may be controlled by dilution with water and the dynamic surface tension may be controlled by adding a surfactant to the coating solution for the outermost layer.

The dynamic surface tension (hereafter also referred to as DST) will now be explained. Generally, it takes certain time before an equilibrium in surface tension is established after a new surface of a solution is formed. For example, when a specific surface area of a solution changes, the surface tension of the solution is changing with time depending on an orienting rate which also depend on the kind of a surfactant and evaporation of a solvent.

Generally, when the surface of a solution is newly formed, the resulting surface tension takes a definite time to reach equilibrium. For example, when the specific surface area changes, the resulting surface tension changes over time depending on the orientation rate due to difference of surface active agents, and evaporation of solvents in the surface layer. It is possible to determine the surface tension in such a non-equilibrium state as a dynamic surface tension. In the present invention, this surface tension is defined as dynamic surface tension.

Employed as methods to determine the dynamic surface tension may be any of those commonly known in the art. Examples include a meniscus method, a dripping method, a γ/A curve method, a vibration jet method, a maximum bulb pressure method, and a curtain coater method (J. Fluid Mech. (1981), Vol. 112, pages 443-458). In the present invention, shown are dynamic surface tension values determined by employing the maximum bubble pressure method.

Listed as specific examples of a surface tension balance based on the maximum bubble pressure method may be BP2 BUBBLE PRESSURE DYNAMIC SURFACE TENSION BALANCE, produced by Kruss Inc. and DYNAMIC SURFACE TENSION METER TYPE BP-D4, produced by Kyowa Interface Science Co., Ltd.

The method to measure a dynamic surface tension of an aqueous coating solution of the present invention is not specifically limited, and a comparatively hydrophobic surfactant as well as a water-soluble organic solvent itself having a low surface tension may be used.

In the present study, the dynamic surface tension was measured at a coating solution temperature of 25° C. using BP2 produced by Kruss Inc. Also, the dynamic surface was measured via a maximum bubble pressure method while bubbles were continuously formed.

Further, as described in the above Item (10), by controlling the viscosity of the coating composition for the outermost layer to be higher than the viscosity of the coating composition for the adjacent layer, coating defects accompanying the simultaneous coating of the ink-absorbing layers tend to be suppressed.

The above viscosity values were measured at 40° C.

The viscometer used in the present invention is not specifically limited. A rotating viscometer and a capillary viscometer may be employed, however, in the present invention, a Brookfield viscometer using a spindle (B-type viscometer) is preferably employed. Since a Brookfield viscometer enables measurement of a wide range of viscosity in combinations of several measuring ranges of the instrument and several types of spindles, the viscosity of a coating composition can be suitably adjusted to a desired value even when an initial viscosity is largely different from the desired viscosity. Brookfield viscometers are commercially available, for example, a digital viscometer DV-11+ from BROOKFIELD(R).

(Cationic Polymer)

A cationic polymer may be contained in the ink-absorbing layer of the present invention, specifically, a cationic polymer is preferably contained is the adjacent layer.

A cationic polymer may be homogeneously added to a coating composition or may be added to a silica dispersed solution to form composite particles. Methods to form composite particles of silica and a cationic polymer include (i) coating silica particles with a cationic polymer by adsorption; (ii) forming a higher degree of composite particles by aggregating primary composite particles; and (iii) preparing homogeneous size of composite particles by pulverizing large aggregated particles in a homogenizer. In the present invention, a cationic polymer is preferably added to a silica dispersed solution.

Cationic polymers are those which have primary, secondary, or tertiary amine, a quaternary ammonium salt group, or a quaternary phosphonium salt group in the main chain or a side chain, and prior art compounds for ink-jet recoding sheets may be employed. In view of ease of the production, water-soluble cationic polymers are preferred. Listed as examples of cationic polymers are polyethyleneimine, polyallylamine, polyvinylamine, dicyandiamidopolyalkylene polyamine condensation products, polyalkylene polyamine dicyandiamidoammonium salt condensation products, dicyandiamido formalin condensation products, epichlorohydrin-dialkylamine addition polymers, diallyldimethylammonium chloride polymers, diallyldimethylammonium chloride-SO₂ copolymers, polyvinylimidazole, vinylpyrrolidone-vinylimadazole copolymers, polyvinylpyridine, polyamidine, chitosan, cationic starch, vinylbenzyltimethylammonium chloride polymers, (2-methacroyloxyethyl)trimethylammonium chloride polymers, and dimethylaminoethyl methacrylate polymers.

Further, the examples also include cationic polymers described in Kagaku Jiho (Chemical Industry News), Aug. 15 and 25, 1998, and polymer dye fixing agents described on page 787 of “Kobunshi Yakuzai Nyumon (Introduction to Polymer Medicines)” (published by Sanyo Chemical Industies, Ltd. 1992).

The average molecular weight of cationic polymers is preferably in the range of 2,000-500,000, but is more preferably in the range of 3,000-100,000.

Further, a cationic polymer may be contained in the outermost layer or a solution of a cationic polymer may be impregnated in the porous layer before or after the layer is dried. Methods to add a cationic polymer solution to the porous layer before drying the layer include, for example, a curtain coating method and spray coating method.

(Surfactants)

It is preferable to incorporate a surfactants into the outermost layer of the ink-absorbing layer of the present invention. Employed as surfactants usable in the ink absorptive layer may be any of the cationic, betaine based, or nonionic surfactants having a suitable affinity to the water-soluble multivalent metal compounds of the present invention. Of these, in view of avoiding cracks on the surface, preferred are cationic and betaine based hydrocarbon surfactants.

Among cationic hydrocarbon surfactants, preferred is that of a quaternary ammonium salt the structure of which is described in JP-A No. 20.03-312134. Among betaine based hydrocarbon surfactants, oxides or those having hydroxyl group are preferable.

A surfactant can also be added to the layers other than the outermost layer. The methods to add a surfactant include (i) adding a surfactant solution prior to a coating composition; (ii) applying a surfactant solution on a coated layer on the support before drying; and (iii) impregnating a surfactant solution in a coated and dried porous layer. Of these, methods (i) and (ii) are preferable. The used amount of those surfactants is preferably 0.0001-1.0 g/m², but is more preferably 0.001-0.5 g/m².

(Hardening Agents)

In the present invention, in order to avoid cracking of an ink-jet recording sheet, which may form in the production process (coating and drying), the binder contained in the outermost layer is preferably hardened by adding a hardening agent in a silica dispersed solution to be used for the outermost layer. A boron containing compound is preferably used as a hardening agent, and a compound containing boric acid or a salt thereof is more preferably used. A boric acid and a salt thereof refers to an oxygen acid having a boron atom as a central atom and a salt thereof, specific examples of which include orthoboric acid, diboric acid, metaboric acid, tetraboric acid, pentaboric acid, octaboric acid, and salts thereof. The used amount of hardening agents varies depending on the type of the hydrophilic binder as well as the type of the cross-linking agent, and is commonly 5-500 mg and is preferably 10-300 mg per g of a hydrophilic binder. When a hardening agent is not used, actinic rays (for example, ultraviolet rays and electron beams) curable binder are preferable.

(Binders)

The ink-jet recording sheet of the present invention preferably contains a binder and more preferably contains at least one hydrophilic binder. Herein, the term “hydrophilic” means not only being soluble in water but also being soluble in a mixed solution of water and a water-miscible organic solvent, for example methanol, isopropanol, acetone and ethyl acetate. “A hydrophilic binder” means a binder which dissolves in water by not less than 1% by weight, and more preferably by not less than 3% by weight. One of the hydrophilic binders preferably employed in the present invention is polyvinyl alcohol. Besides commonly used polyvinyl alcohol prepared by hydrolyzing polyvinyl acetate, modified polyvinyl alcohols, for example, the one terminal of which is anion-modified, or the one having a benzene ring group are also preferably used.

The average polymerization degree of polyvinyl alcohol is preferably not less than 1500 and, in view of avoiding cracks formed in the production process (coating and drying), more preferably not less than 3000. The degree of saponification is preferably 70 to 100%, and specifically preferably 80 to 99.5%. When a hardening agent is not used, a photo-crosslinkable nonionic binder is preferably used.

(Other Additives)

In the present invention, additives other than the above-mentioned may be contained in the ink-absorbing layers and, if necessary, in other layers. Specifically, a UV-ray absorbing agent, an antioxidant, anti-bleeding agent and image retention enhancer are preferably contained. Further preferably contained additives include well known additives in the art, for example: an aqueous emulsion containing such as polystyrene, a polyacrylic acid ester and a polymethacrylic acid ester; urea and its analogue; an anti-fading agent; a fluorescent brightner; a light stability enhancer; a pH adjuster such as sodium hydroxide and sodium acetate; an antifoaming agent; an antiseptic agent; a thickener; an antistatic agent; and a matting agent.

(Supports)

The support employed in the present invention will now be explained. In the present invention, a non-water absorbing support which avoids cockling while printing is preferably used. As non-water absorbing supports, listed are plastic resinous film supports and supports coated with a plastic resinous film, on both sides of a paper sheet. Examples of a plastic resinous film support include, for example: a polyester film, a polyvinyl chloride film, a polypropylene film, a cellulose triacetate film, a polystyrene film and a laminated support thereof. It is possible to use those plastic resinous films which are transparent or translucent. Of these, one of the most preferable supports is a paper support both side surfaces of which are coated with polyolefin films.

(Ink)

A recording method employing an aqueous ink is preferably applied for the ink-jet recording sheet of the present invention.

The above mentioned aqueous ink contains a colorant which will be explained below, and other additives. Examples of a colorant include: a direct dye known in the art as an ink-jet ink, an acidic dye, a basic dye, a reactive dye, an water-soluble dye for food and a water-dispersive pigment.

As a solvent for an aqueous ink, water and various organic solvents are applicable, examples of which include: polyalcohols such as diethylene glycol, triethanolamine, and glycerin; triethylene glycol monobutyl ether; and a lower ether of a polyalcohol.

Examples of other additive include: a pH adjuster, a sequestrant, a fungicide, a thickener, a surfactant, a moisturizer and an anti-corrosion agent.

In order to attain desirable wettability of an aqueous ink on an ink-jet recording sheet, the aqueous ink preferably has a surface tension of 0.025 to 0.06 N/m, and more preferably 0.03 to 0.05 N/m. The pH value of the aqueous ink is preferably 5 to 10, and specifically preferably 6 to 9.

### EXAMPLES

The present invention will now be specifically explained using examples, however the present invention is not limited thereto. The symbol “%” used in the examples represents “% by weight” unless otherwise specifically specified.

### <<Praparation of Ink-Jet Recording Sheet>>

(Preparation of Silica Dispersed Solution A)

Into pure water containing 2% of ethanol, a pH value of which was adjusted to 3 using nitric acid, vapor deposited silica (REOLOSIL(R) QS-20 produced by TOKUYAMA Corp.) was disperse to form 4000 g of silica dispersed solution containing 20% of silica. Into the resulting solution, 220 g of an aqueous solution containing 28% of cationic polymer (PAS-H-5L produced by NITTO BOSEKI Co., Ltd.); and a 1000 g of aqueous solution in which 21 g of boric acid and 15 g of pyroborate were dissolved; were added and the contents were dispersed using a high-pressure homgenizer produced by SANWA MACHINE Co., INc. Thus Silica Dispersed Solution A was obtained.

[Preparation of Recording Sheet 1 (Comparative Sample)]

(Hereafter an ink-jet recording sheet is merely referred to as a recording sheet)

A photographic support was prepared from a row paper of 200 g/m² by coating both surfaces with polyethylene (total thickness: 220 μm). On the recording surface of the above support, coating compositions for the first layer, the second layer, the third layer and the fourth layer were applied in wet thicknesses of 40, 40, 40 and 40 μm, respectively, then the coated support was cooled at 5° C. for 10 seconds, followed by drying in an air flow at 40° C. Thus Recording Sheet 1 was prepared. The coating compositions for the first layer through the fourth layer will be described below.

(Coating compositions for the first layer (undermost layer), the second layer and the third layer (adjacent layer)

| | |
|---|---|
| Silica Dispersed Solution | 550 g |
| Aqueous solution containing 6% of Polyvinyl alcohol | 280 g |
| (PVA235 produced by KURARAY CO., LTD) | |
| Pure water was added to make total volume of 1000 ml. | |
| (Coating composition for the Fourth layer (outermost layer)) | |
| Silica Dispersed Solution A | 600 g |
| Aqueous solution containing 6% of Polyvinyl alcohol | 280 g |
| (PVA235 produced by KURARAY CO., LTD) | |
| Aqueous solution containing 4% of cationic surfactant | 4 ml |
| (QUARTAMIN 24P, produced by Kao Corp.) | |
| Aqueous solution containing 4% of ampholytic surfactant | 1 ml |
| (FUTERGENT 400S, produced by Neos Co., Ltd.) | |

Pure water was added to make total volume of 1000 ml.

[Preparation of Recording Sheet 2 (Comparative Sample)]

Recording Sheet 2 was prepared in the same manner as Recording Sheet 1 except that 0.88 g of zirconyl acetate (ZIRCOZOL ZA-30 produced by Daiichi Kigenso Kagaku-Kogyo Co., Ltd., the weight being converted to a weight of the same equivalent of ZrO₂) was added to the coating composition for the third layer (adjacent layer).

[Preparation of Recording Sheet 3 (Comparative Sample)]

Recording Sheet 3 was prepared in the same manner as Recording Sheet 1 except that 19 g of basic aluminum chloride (TAKIBINE #1500, produced by Taki Chemical Co., Ltd., the weight being converted to a weight of the same equivalent of Al₂O₃ (AlO_{3/2})) was added to the coating composition for the fourth layer (outermost layer) and that the wet thicknesses of the first, second, third and fourth layer were 50, 40, 50, 20 μm, respectively.

[Preparation of Recording Sheet 4 (Inventive Sample)]

Recording Sheet 4 was prepared in the same manner as Recording Sheet 3 except that the coating composition for the fourth layer (outermost layer) was also used for the third layer (adjacent layer).

[Preparation of Recording Sheet 5 (Inventive Sample)]

Recording Sheet 5 was prepared in the same manner as Recording Sheet 1 except that 19 g of basic aluminum chloride (TAKIBINE #1500, produced by Taki Chemical Co., Ltd., the weight being converted to a weight of the same equivalent of Al₂O₃ (AlO_{3/2})) was added to the coating composition for the fourth layer (outermost layer) and that the pH value of the coating composition for the third layer (adjacent layer) was adjusted to 4.1 using nitric acid.

[Preparation of Recording Sheet 6 (Inventive Sample)]

Recording Sheet 6 was prepared in the same manner as Recording Sheet 5 except that no nitric acid was added in the coating composition for the third layer (adjacent layer) and that 0.59 g of basic aluminum chloride (the weight being converted to a weight of the same equivalent of Al₂O₃ (AlO_{3/2})) was added to the coating composition for the third layer (adjacent layer).

[Preparation of Recording Sheet 7 (Comparative Sample)]

Recording Sheet 7 was prepared in the same manner as Recording Sheet 2 except that 1.2 g of zirconyl acetate (the weight being converted to a weight of the same equivalent of ZrO₂) was added to the coating composition for the fourth layer (outermost layer).

[Preparation of Recording Sheet 8 (Inventive Sample)]

Recording Sheet 8 was prepared in the same manner as Recording Sheet 3 except that the basic aluminum chloride contained in the coating composition for the fourth layer (outermost layer) was replaced with the same weight of zirconyl acetate, the weight being based on the weight of ZrO₂.

[Preparation of Recording Sheet 9 (Inventive Sample)]

Recording Sheet 9 was prepared in the same manner as Recording Sheet 3 except that the amount of the basic aluminum chloride added to the coating composition for the fourth layer (outermost layer) was changed to 6.4 g (the weight being converted to a weight of the same equivalent of Al₂O₃ (AlO_{3/2}))and that 0.88 g of basic aluminum chloride was added to the coating composition for the third layer (adjacent layer, the weight being converted to a weight of the same equivalent of Al₂O₃ (AlO_{3/2})).

[Preparation of Recording Sheet 10 (Inventive Sample)]

Recording Sheet 10 was prepared in the same manner as Recording Sheet 7 except that the amount of the zirconyl acetate added to the coating composition for the fourth layer (outermost layer) was changed to 19 g (the weight being converted to a weight of the same equivalent of ZrO₂).

[Preparation of Recording Sheet 11 (Inventive Sample)]

Recording Sheet 11 was prepared in the same manner as Recording Sheet 8 except that 0.88 g of zirconyl acetate (the weight being converted to a weight of the same equivalent of ZrO₂) was added to the coating composition for the third layer (adjacent layer) and that the pH value of the coating composition for the third layer (adjacent layer) was adjusted to 4.9 using an aqueous solution containing 40% of sodium acetate.

[Preparation of Recording Sheet 12 (Inventive Sample)]

Recording Sheet 12 was prepared in the same manner as Recording Sheet 11 except that no sodium acetate was used in the coating composition for the third layer (adjacent layer).

[Preparation of Recording Sheet 13 (Inventive Sample)]

Recording Sheet 13 was prepared in the same manner as Recording Sheet 3 except that 0.88 g of basic aluminum chloride (the weight being converted to a weight of the same equivalent of Al₂O₃ (AlO_{3/2})) was added to the coating composition for the third layer (adjacent layer). The dynamic surface tension of the coating composition for the outermost layer was 61 mN/m (DST; 50 mS) and that of the coating composition for the adjacent layer was 68 mN/m (DST; 50 mS). The viscosity of the coating composition for the outermost layer was 45 mPa•s and that of the coating composition for the adjacent layer was 37 mPa•s.

[Preparation of Recording Sheet 14 (Comparative Sample)]

Recording Sheet 14 was prepared in the same manner as Recording Sheet 13 except that the amount of the basic aluminum chloride added to the coating composition for the third layer (adjacent layer) was changed to 0.35 g (the weight being converted to a weight of the same equivalent of Al₂O₃ (AlO_{3/2})).

[Preparation of Recording Sheet 15 (Comparative Sample)]

Recording Sheet 15 was prepared in the same manner as Recording Sheet 13 except that the amount of basic aluminum chloride added to the coating composition for the third layer (adjacent layer) was changed to 2.2 g and that the pH value of the coating composition for the third layer was adjusted to 4.4 using an aqueous solution containing 40% of sodium acetate.

[Preparation of Recording Sheet 16 (Inventive Sample)]

Recording Sheet 16 was prepared in the same manner as Recording Sheet 15 except that no sodium acetate was used in the coating composition for the third layer (adjacent layer).

[Preparation of Recording Sheet 17 (Inventive Sample)]

Recording Sheet 17 was prepared in the same manner as Recording Sheet 13 except that the basic aluminum chloride contained in the coating composition for the third layer (adjacent layer) was replaced with the same weight of zirconyl acetate, the weight being based on the weight of ZrO₂.

[Preparation of Recording Sheet 18 (Inventive Sample)]

Recording Sheet 18 was prepared in the same manner as Recording Sheet 13 except that the basic aluminum chloride contained in the coating composition for the fourth layer (outermost layer) was replaced with the same weight of magnesium chloride, the weight being based on the weight of MgO.

[Preparation of Recording Sheet 19 (Inventive Sample)]

Recording Sheet 19 was prepared in the same manner as Recording Sheet 13 except that the basic aluminum chloride contained in the coating composition for the fourth layer (outermost layer) was replaced with the same weight of basic aluminum lactate (TAKICERAM M-160P produced by Taki Chemical Co., Ltd.), the weight being based on the weight of Al₂O₃.

[Preparation of Recording Sheet 20 (Inventive Sample)]

Recording Sheet 20 was prepared in the same manner as Recording Sheet 13 except that the basic aluminum chloride contained in the coating composition for the fourth layer (outermost layer) was replaced with the same weight of calcium chloride, the weight being based on the weight of CaO.

[Preparation of Recording Sheet 21 (Inventive Sample)]

Recording Sheet 21 was prepared in the same manner as Recording Sheet 18 except that the basic aluminum chloride contained in the coating composition for the third layer (adjacent layer) was replaced with the same weight of magnesium chloride, the weight being based on the weight of MgO.

[Preparation of Recording Sheet 22 (Inventive Sample)]

Recording Sheet 22 was prepared in the same manner as Recording Sheet 13 except that the vapor deposited silica particles were replaced with precipitated silica particles (FINESIL(R) X37B produced by TOKUYAMA Corp.).

[Preparation of Recording Sheet 23 (Inventive Sample)]

Recording Sheet 23 was prepared in the same manner as Recording Sheet 13 except that the coating composition for the fourth layer (outermost layer) was diluted by adding 5% of pure water to adjust the viscosity to 30 mPa•s.

[Preparation of Recording Sheet 24 (Inventive Sample)]

Recording Sheet 24 was prepared in the same manner as Recording Sheet 13 except that no surfactant was used in the coating composition for the fourth layer (outermost layer). The dynamic surface tension of the coating composition of the outermost layer was 70 mN/m.

Dynamic surface tensions (DST) were measured at 25° C. while bubbles were continuously formed in every 50 ms using BP2 BUBBLE PRESSURE DYNAMIC SURFACE TENSION BALANCE, produced by Kruss Inc.

Dry thicknesses of the ink-absorbing layers were measured by taking a picture of the cross-section of each sample using a scanning electron microscope, after adjusting the moisture for 5 hours at 25° C. The dry thicknesses of the outermost layers were in the range of 9.8 to 10.4 μm for Recording Sheets 1, 2, 5-7, 10 in which the wet thicknesses of the first, the second, the third and the fourth ink-absorbing layers were 40, 40, 40 and 40 μm, respectively. The observed dry thicknesses were in the range of 24.5 to 26% based on the total thicknesses of the ink-absorbing layers (thicker outermost layers). Alternatively, the dry thicknesses of the outermost layers were in the range of 4.8 to 5.1 μm for Recording Sheets 3, 4, 8, 9 and 11-24 in which the wet thicknesses of the first, the second, the third and the fourth ink-absorbing layers were 50, 40, 50 and 20 μm, respectively. The observed dry thicknesses were in the range of 12.0 to 12.8% based on the total thicknesses of the ink-absorbing layers (thinner outermost layers).

### <<Evaluations>>

(Coating Defects)

The number of cracks more than 0.2 mm in an area of 10×10 cm² of each Recording Sheet was counted using a loupe. Also, stripe defects were examined with eyes. Herein, the stripe defects mean parallel stripes along a coating direction observed on a recording sheet. The criteria of evaluation were as follows:
A: Number of cracks was 5 or less, and no stripe defect was observed.
B: Number of cracks was 6 through 10, and stripe defects were slightly observed with eyes.
C: Number of cracks was 11 or more and stripe defects were clearly observed with eyes.

Recording sheets receiving an evaluation of A or B among the above criteria of evaluation were considered to be suitable for practical use.

(Image Density)

A black solid print on each recording sheet was carried out using an ink-jet printer PMG800 produced by SEIKO EPSON Corp. After drying for 4 hours, a reflection density of each recording sheet was measured by using a spectrodensitometer (X-RITE938 produced by X-RITE).

(Glossiness)

The glossiness of the recording surface of each recording sheet was evaluated using an image clarity “C value” (%) defined in JIS K 7105 or JIS H 8686-2 (MOD ISO 10215:92). Measurements were carried out using Image Clarity Meter ICM-1DP (manufactured by Suga Test Machine Co., Ltd.) at a reflection angle of 60°.

(Zeta (ζ) Potential)

In the present invention, zeta potentials were measured by using a zeta potential meter for concentrated solutions (ESA-9800 produced by Metec Applied Sciences) at 25° C. using a coating composition having solid content of 3% (the concentration is converted to that of the same equivalent of SiO₂)).

(pH)

pH measurements of coating compositions for the third layer (adjacent layer) and the fourth layer (outermost layer) were carried out at 25° C.

(Viscosity)

Viscosities of coating compositions were measured at 40° C. using a digital viscometer DV-11+ produced BROOKFIELD.

(Dynamic Surface Tension)

Dynamic surface tensions (DST) were measured while bubbles were continuously formed in every 50 ms using BP2 BUBBLE PRESSURE DYNAMIC SURFACE TENSION BALANCE, produced by Kruss Inc. at 25° C. by.

TABLE 1

| | | Outer most | | | | Adjacent | | |
|---|---|---|---|---|---|---|---|---|
| | | layer/water | | | | layer/Water | | |
| | | soluble | | Maximum | | soluble | | |
| | | multivalent | ζ | ionic | | multivalent | | Adjacent |
| | | metal | potential | intensity | | metal | | layer |
| No. | | compound | (mV) | peak | pH | compound | pH | MO_{x/2}/SiO₂ |
| 1 | Comp. | non | 40 | around | 4.5 | non | 4.5 | 0.000 |
| | | | | 25 μm | | | | |
| 2 | Comp. | non | 40 | around | 4.5 | Zirconyl | 4.3 | 0.010 |
| | | | | 25 μm | | acetate | | |
| 3 | Comp. | Basic | 55 | within | 3.7 | non | 4.5 | 0.000 |
| | | aluminum | | 10 μm | | | | |
| | | chloride | | | | | | |
| 4 | Comp. | Basic | 55 | around | 3.7 | Basic | 3.7 | 0.200 |
| | | aluminum | | 25 μm | | aluminum | | |
| | | chloride | | | | chloride | | |
| 5 | Inv. | Basic | 55 | 11-20 | 3.7 | non | 4.1 | 0.000 |
| | | aluminum | | μm | | | | |
| | | chloride | | | | | | |
| 6 | Inv. | Basic | 55 | 11-20 | 3.7 | Basic | 4.4 | 0.007 |
| | | aluminum | | μm | | aluminum | | |
| | | chloride | | | | chloride | | |
| 7 | Comp. | Zirconyl | 45 | 11-20 | 4.5 | Zirconyl | 4.3 | 0.010 |
| | | acetate | | μm | | acetate | | |
| 8 | Inv. | Zirconyl | 51 | within | 4.2 | non | 4.5 | 0.000 |
| | | acetate | | 10 μm | | | | |
| 9 | Inv. | Basic | 48 | within | 4 | Basic | 4.3 | 0.010 |
| | | aluminum | | 10 μm | | aluminum | | |
| | | chloride | | | | chloride | | |
| 10 | Inv. | Zirconyl | 51 | 11-20 | 4.2 | Zirconyl | 4.3 | 0.010 |
| | | acetate | | μm | | acetate | | |
| 11 | Inv. | Zirconyl | 51 | within | 4.2 | Zirconyl | 4.9 | 0.010 |
| | | acetate | | 10 μm | | acetate | | |
| 12 | Inv. | Zirconyl | 51 | within | 4.2 | Zirconyl | 4.3 | 0.010 |
| | | acetate | | 10 μm | | acetate | | |
| 13 | Inv. | Basic | 55 | within | 3.7 | Basic | 4.3 | 0.010 |
| | | aluminum | | 10 μm | | aluminum | | |
| | | chloride | | | | chloride | | |
| 14 | Comp. | Basic | 55 | within | 3.7 | Basic | 4.6 | 0.004 |
| | | aluminum | | 10 μm | | aluminum | | |
| | | chloride | | | | chloride | | |
| 15 | Comp. | Basic | 55 | within | 3.7 | Basic | 4.4 | 0.025 |
| | | aluminum | | 10 μm | | aluminum | | |
| | | chloride | | | | chloride | | |
| 16 | Inv. | Basic | 55 | within | 3.7 | Basic | 4.2 | 0.025 |
| | | aluminum | | 10 μm | | aluminum | | |
| | | chloride | | | | chloride | | |
| 17 | Inv. | Basic | 55 | within | 3.7 | Zirconyl | 4.3 | 0.010 |
| | | aluminum | | 10 μm | | acetate | | |
| | | chloride | | | | | | |
| 18 | Inv. | Magnesium | 51 | within | 4.7 | Basic | 4.3 | 0.010 |
| | | chloride, | | 10 μm | | aluminum | | |
| | | hexahydrate | | | | chloride | | |
| 19 | Inv. | Basic | 52 | within | 4 | Basic | 4.3 | 0.010 |
| | | aluminum | | 10 μm | | aluminum | | |
| | | lactate | | | | chloride | | |
| 20 | Inv. | Calcium | 54 | within | 4.7 | Basic | 4.3 | 0.010 |
| | | chloride | | 10 μm | | aluminum | | |
| | | | | | | chloride | | |
| 21 | Inv. | Magnesium | 51 | within | 4.7 | Magnesium | 4.5 | 0.010 |
| | | chloride, | | 10 μm | | chloride | | |
| | | hexahydrate | | | | | | |
| 22 | Inv. | Basic | 51 | within | 4.2 | Basic | 4.3 | 0.010 |
| | | aluminum | | 10 μm | | aluminum | | |
| | | chloride | | | | chloride | | |
| 23 | Inv. | Basic | 51 | within | 4.2 | Basic | 4.3 | 0.010 |
| | | aluminum | | 10 μm | | aluminum | | |
| | | chloride | | | | chloride | | |
| 24 | Inv. | Basic | 51 | within | 4.2 | Basic | 4.3 | 0.010 |
| | | aluminum | | 10 μm | | aluminum | | |
| | | chloride | | | | chloride | | |

| | | | Glossiness | | |
|---|---|---|---|---|---|
| | Outermost layer | | (Clarity: C value) | Image density | Image defects |
| No. | MO_{x/2}/SiO₂ | *1 | (%) | (Black) | (stripes, cracks) |
| 1 | 0.000 | 25.0% | 50 | 1.95 | A |
| 2 | 0.000 | 25.0% | 55 | 1.95 | A |
| 3 | 0.200 | 12.5% | 43 | 2.20 | C |
| 4 | 0.200 | 12.5% | 56 | 2.00 | A |
| 5 | 0.200 | 25.0% | 60 | 2.14 | A |
| 6 | 0.200 | 25.0% | 61 | 2.13 | A |
| 7 | 0.013 | 25.0% | 55 | 1.98 | A |
| 8 | 0.200 | 12.5% | 58 | 2.15 | A |
| 9 | 0.067 | 12.5% | 59 | 2.10 | A |
| 10 | 0.200 | 25.0% | 60 | 2.12 | A |
| 11 | 0.200 | 12.5% | 58 | 2.17 | A |
| 12 | 0.200 | 12.5% | 63 | 2.18 | A |
| 13 | 0.200 | 12.5% | 67 | 2.20 | A |
| 14 | 0.200 | 12.5% | 45 | 2.15 | C |
| 15 | 0.200 | 12.5% | 48 | 2.03 | B |
| 16 | 0.200 | 12.5% | 55 | 2.15 | A |
| 17 | 0.200 | 12.5% | 58 | 2.14 | A |
| 18 | 0.200 | 12.5% | 55 | 2.14 | A |
| 19 | 0.200 | 12.5% | 61 | 2.18 | A |
| 20 | 0.200 | 12.5% | 55 | 2.13 | A |
| 21 | 0.200 | 12.5% | 53 | 2.10 | A |
| 22 | 0.200 | 12.5% | 58 | 2.13 | A |
| 23 | 0.200 | 12.5% | 55 | 2.14 | B |
| 24 | 0.200 | 12.5% | 57 | 2.14 | B |

Inv.: Inventive Sample, Comp.: Comparative Sample
*1) % of outermost layer thickness based on total ink-absorbing layer thickness

What is claimed is:

1. An ink-jet recording sheet comprising a non-water absorbing support having thereon at least two simultaneously coated ink-absorbing layers, each ink-absorbing layer containing silica particles,
wherein:
(i) an outermost layer of the ink-absorbing layers and a layer adjacent to the outermost layer each contains a water-soluble multivalent metal compound;
(ii) the outermost layer is formed by a coating composition having an average zeta potential of not less than +50 mV at 25° C.;
(iii) a MO_{x/2}/SiO₂ value in the layer adjacent to the outermost layer is in the range of 0.005-0.02, provided that MO_{x/2} represents a weight of the water-soluble multivalent metal compound based on a weight of MO_{x/2}, and SiO₂ represents a weight of the silica particles; and
(iv) a MO_{x/2}/SiO₂ value in the outermost layer is larger than a MO_{x/2}/SiO₂ value in any ink-absorbing layer other than the outermost layer,
wherein:
M represents a metal having a valence of two or more contained in the water-soluble multivalent metal compound; and
x represents a valence of the metal M.

2. An ink-jet recording sheet comprising a non-water absorbing support having thereon at least two simultaneously coated ink-absorbing layers, each ink-absorbing layer containing silica particles,
wherein:
(i) an outermost layer of the ink-absorbing layers further contains a water-soluble multivalent metal compound;
(ii) the outermost layer is formed by a coating composition having an average zeta potential of not less than +50 mV at 25° C.;
(iii) a difference between a pH value of a coating composition for the outermost layer and a pH value of a coating composition for a layer adjacent to the outermost layer is not more than 0.6 at 25° C.; and
(iv) a MO_{x/2}/SiO₂ value in the outermost layer is larger than a MO_{x/2}/SiO₂ value in any ink-absorbing layer other than the outermost layer, provided that MO_{x/2} represents a weight of the water-soluble multivalent metal compound based on a weight of MO_{x/2}, and SiO₂ represents a weight of the silica particles,
wherein
M represents a metal having a valence of two or more contained in the water-soluble multivalent metal compound; and
x represents a valence of the metal M.

3. An ink-jet recording sheet comprising a non-water absorbing support having thereon at least two simultaneously coated ink-absorbing layers, each ink-absorbing layer containing silica particles,
wherein:
(i) an outermost layer of the ink-absorbing layers and a layer adjacent to the outermost layer each contains a water-soluble multivalent metal compound;
(ii) a thickness distribution of secondary ion intensity showing existence of the water-soluble multivalent metal compound of the ink-absorbing layers exhibits a peak within 10 μm from an outermost surface of the outermost layer, the secondary ion intensity being determined by time of flight secondary ion mass spectrometry (TOF-SIMS);
(iii) a MO_{x/2}/SiO₂ value in the layer adjacent to the outermost layer is in the range of 0.005-0.02, provided that MO_{x/2} represents a weight of the water-soluble multivalent metal compound based on a weight of MO_{x/2}, and SiO₂ represents a weight of the silica particles; and
(iv) a MO_{x/2}/SiO₂ value in the outermost layer is larger than a MO_{x/2}/SiO₂ value in any ink-absorbing layer other than the outermost layer,
wherein:
M represents a metal having a valence of two or more contained in the water-soluble multivalent metal compound; and
x represents a valence of the metal M.

4. An ink-jet recording sheet comprising a non-water absorbing support having thereon at least two simultaneously coated ink-absorbing layers, each ink-absorbing layer containing silica particles,
wherein:
(i) an outermost layer of the ink-absorbing layers further contains a water-soluble multivalent metal compound;
(ii) a thickness distribution of secondary ion intensity showing existence of the water-soluble multivalent metal compound of the ink-absorbing layers exhibits a peak within 10 μm from an outermost surface of the outermost layer, the secondary ion intensity being determined by time of flight secondary ion mass spectrometry (TOF-SIMS);
(iii) a difference between a pH value of a coating composition for the outermost layer and a pH value of a coating composition for a layer adjacent to the outermost layer is not more than 0.6 at 25° C.; and
(iv) a MO_{x/2}/SiO₂ value in the outermost layer is larger than a MO_{x/2}/SiO₂ value in any ink-absorbing layer other than the outermost layer, provided that MO_{x/2} represents a weight of the water-soluble multivalent metal compound based on a weight of MO_{x/2}, and SiO₂ represents a weight of the silica particles,
wherein
M represents a metal having a valence of two or more contained in the water-soluble multivalent metal compound; and
x represents a valence of the metal M.

5. The ink-jet recording sheet of claim 1,
wherein the MO_{x/2}/SiO₂ ratio in the outermost layer is not less than 0.1.

6. The ink-jet recording sheet of claim 1,
wherein a dry thickness of the outermost layer is in the range of 2-20% of a total dry thickness of the ink-absorbing layers.

7. The ink-jet recording sheet of claim 1,
wherein the water-soluble multivalent metal compound contains aluminum atoms or zirconium atoms.

8. The ink-jet recording sheet of claim 1,
wherein the water-soluble multivalent metal compound contained in the layer adjacent to the outermost layer and the water-soluble multivalent metal compound contained in the outermost layer contain a common metal element.

9. A method for producing the ink-jet recording sheet of claim 1 comprising the step of:
simultaneously coating at least two coating compositions on the non-water absorbing support to form the ink-absorbing layers,
wherein a viscosity of the coating composition for the outermost layer is higher than a viscosity of a coating composition for the layer adjacent to the outermost layer.

10. The ink-jet recording sheet of claim 2,
wherein the MO_{x/2}/SiO₂ ratio in the outermost layer is not less than 0.1.

11. The ink-jet recording sheet of claim 2,
wherein a dry thickness of the outermost layer is in the range of 2-20% of a total dry thickness of the ink-absorbing layers.

12. The ink-jet recording sheet of claim 2,
wherein the water-soluble multivalent metal compound contains aluminum atoms or zirconium atoms.

13. A method for producing the ink-jet recording sheet of claim 2 comprising the step of:
simultaneously coating at least two coating compositions on the non-water absorbing support to form the ink-absorbing layers,
wherein a viscosity of the coating composition for the outermost layer is higher than a viscosity of a coating composition for a layer adjacent to the outermost layer.

14. The ink-jet recording sheet of claim 3,
wherein the MO_{x/2}/SiO₂ ratio in the outermost layer is not less than 0.1.

15. The ink-jet recording sheet of claim 3,
wherein the water-soluble multivalent metal compound contains aluminum atoms or zirconium atoms.

16. The ink-jet recording sheet of claim 3,
wherein the water-soluble multivalent metal compound contained in the layer adjacent to the outermost layer and the water-soluble multivalent metal compound contained in the outermost layer contain a common metal element.

17. A method for producing the ink-jet recording sheet of claim 3 comprising the step of:
simultaneously coating at least two coating compositions on the non-water absorbing support to form the ink-absorbing layers,
wherein a viscosity of the coating composition for the outermost layer is higher than a viscosity of a coating composition for the layer adjacent to the outermost layer.

18. The ink-jet recording sheet of claim 4,
wherein the MO_{x/2}/SiO₂ ratio in the outermost layer is not less than 0.1.

19. The ink-jet recording sheet of claim 4,
wherein the water-soluble multivalent metal compound contains aluminum atoms or zirconium atoms.

20. A method for producing the ink-jet recording sheet of claim 4 comprising the step of:
simultaneously coating at least two coating compositions on the non-water absorbing support to form the ink-absorbing layers,
wherein a viscosity of the coating composition for the outermost layer is higher than a viscosity of a coating composition for a layer adjacent to the outermost layer.
